(19) United States
(12) Patent Application Publication
(10) Pub. No.: US 2024/0340176 A1
(43) Pub. Date: Oct. 10, 2024

(54) Compression Technique

(71) Applicant: Crown Sterling Limited, LLC, Newport Beach, CA (US)

(72) Inventor: Robert Edward Grant, Laguna Beach, CA (US)

(21) Appl. No.: 18/130,613

(22) Filed: Apr. 4, 2023

(51) Int. Cl. H04L 9/30; H03M 7/30

(52) U.S. Cl. CPC H04L 9/3026; H03M 7/3059

(57) ABSTRACT

A system and method for transforming data using a cypher key. To reverse transformed data, a computing device applies a mathematical function to a cypher key to generate a set of possible values. The computing device then tests the set of possible values against a confirmation sequence to determine the correct value, which is used to resolve the target sequence. The resolution of the target sequence can include a decompression of compressed data or a decryption of encrypted data.

### FIELD OF THE INVENTION

The field of the invention is cryptography and data compression.

### BACKGROUND

The following description includes information that may be useful in understanding the present invention. It is not an admission that any of the information provided herein is prior art or relevant to the presently claimed invention, or that any publication specifically or implicitly referenced is prior art.

In an increasingly digital world, the topics of data storage and data security are of primary importance. As applications and media grow in size and complexity, the space they require for storage increases. This is true for both underlying data, and for keys used in encryption-decryption.

Data compression has long been used to reduce storage needs. However, existing processes can be computationally intensive and/or take unacceptably long to perform. In a completely lossless compression scheme, currently obtainable compression ratios are undesirable, especially for compressing numeric strings.

The present inventor has already addressed these issues in U.S. Ser. No. 17/018,582, which teaches multiple systems and methods for storing and distributing large keys, U.S. Ser. No. 17/533,374, which teaches partial cryptographic key transport using one-time pad encryption, and U.S. Ser. No. 17/533,049, which teaches Use Of Random Entropy In Cryptography. These and all other publications referenced herein are incorporated by reference to the same extent as if each individual publication were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Nevertheless, there is still a need for improved data compression technologies.

### SUMMARY OF THE INVENTION

The inventive subject matter provides apparatus, systems and methods in which a cypher key is used for data transformation (e.g., compression-decompression, encryption-decryption, etc.). An important aspect of the inventive subject matter is an appreciation of the fact that lossless compression-decompression can be achieved using a decompression function that is only partially determinative. Whatever algorithm is used to decompress intentionally resolves to multiple choices that can then be tested to determine which can provide the proper decompression.

In preferred implementations, a computing device applies a mathematical function to a cypher key that resolves to a set of possible values having at least first and second members. From the set of possible values, the computing device identifies a successful value by testing the members against a confirmation sequence. Upon finding a successful value, the computing device uses the located successful value to resolve a target sequence.

In compression/decompression, the target sequence can be the original uncompressed data set. The cypher key in this case would be the compressed data and additional information such that the data can be uncompressed.

In some embodiments of the inventive subject matter, a decompression process can involve finding a distance of the uncompressed data from a perfect square value, wherein the uncompressed data is of a known length.

The partially determinative aspects of the processes discussed herein allow for compression ratios that were not previously achievable, especially for longer numeric strings.

Various objects, features, aspects and advantages of the inventive subject matter will become more apparent from the following detailed description of preferred embodiments, along with the accompanying drawing figures.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

### BRIEF DESCRIPTION OF THE DRAWINGS

FIG. 1 is a flowchart of the processes executed to transform a set of data, according to embodiments of the inventive subject matter.

FIG. 2 is a flowchart of an example of a compression process that involves calculating a distance from a perfect square.

FIG. 3 is a flowchart where the process of uncompressing the data that was compressed in the process of FIG. 2.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network. The following description includes information that may be useful in understanding the present invention. It is not an admission that any of the information provided herein is prior art or relevant to the presently claimed invention, or that any publication specifically or implicitly referenced is prior art.

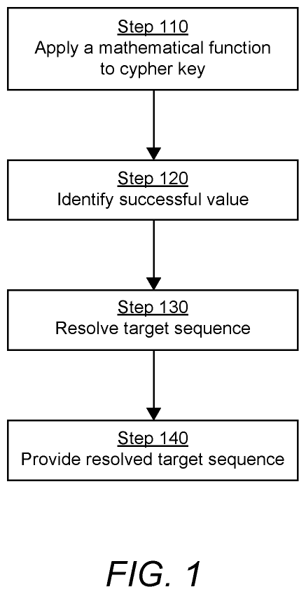

FIG. 1 is a flowchart of the processes executed to transform a set of data, according to embodiments of the inventive subject matter. As will be discussed in more detail below, a transformation of a set of data can include an encryption, decryption, compression and/or decompression of part of or all of a set of data. The processes discussed herein are discussed as being performed by a computing device or computing system, which can include one or more individual computer devices each having one or more processors and one or more physical, non-transitory computer readable memory that stores the data and execution code for the processes discussed herein.

At step 110, a computing device applies a mathematical function at least a first portion of a cypher key, where the function resolves to a set of possible values having at least first and second members. In embodiments of the inventive subject matter, the first member can be the compressed target sequence and the second member can be information used to decompress the target sequence (e.g., a length of the total target sequence to be decompressed). In other embodiments of the inventive subject matter, the first member can be the encrypted target sequence and the second member can correspond to the length of the unencrypted target sequence.

The cypher key generally is a numeric string or key that contains sufficient information for a computing device do transform a set of data. The cypher key can be used for compression, decompression, encryption, decryption or other data transformation processes. In embodiments discussed herein, the cypher key can be generated during a compression or encryption process and then used for decompression/decryption of the original data.

When referring to “at least a first portion of a cypher key”, it is intended to also include wherein the first portion comprises the entirety of the cypher key, as well as less than the entirety of the cypher key.

Step 110 can include, for certain cypher keys such as alphanumeric keys, first converting by the computing device the cypher key or a portion of the cypher key to a corresponding numeric key and then applying the mathematical function to numeric key. For example, the cypher key (or the first portion of the cypher key) can be an alphabetic or alphanumeric string. In another example, the cypher key can be embedded into an image file, video file, or audio file. For example, the cypher key can be inserted to appear in an image or digital file, or as an audio signal within an audio or video file.

In embodiments of the inventive subject matter, the first mathematical function can be a polynomial equation wherein the first portion of the cypher key and a second portion of the cypher key are used as constants.

For example, the mathematical function can be the quadratic equation ax²+bx+c=0. The target sequence or a portion of the target sequence to be transformed is used as the variable “x”, and a value is assumed for the constant “c”. Then the equation is solved for “a” and “b”, which correspond to the first and second portions of the cypher key. These first and second portions of the cypher key are then joined to form the cypher key.

For the reverse process to derive the target sequence, the computing device first divides the cypher key into the first and second portions and then solves for X (again, having the constant “c” already known). In security applications, the computing device (which could be a device that is receiving an encrypted message), would not know exactly how to parse the cypher key to generate the first and second portions and so would have to try multiple iterations of possible first and second portions before arriving at the correct target sequence.

It should be appreciated that, in embodiments, “c” can also be left to be solved which increases the complexity of the process and thus the security.

In another embodiment of the inventive subject matter, the first mathematical function is a function used to calculate the dimensions of a geometric figure and the first portion and a second portion of the cypher key are constants used in calculating these dimensions. For example, the mathematical function can be the formula to find the hypotenuse of a right triangle—the square root of (a²+b²). In this case, the target sequence used to generate the cypher key can be the value of the hypotenuse and the computing device solves for “a” and “b”, which correspond to the first and second portions of the cypher key. Then the values are joined to form the cypher key. Then, to obtain the target sequence from the cypher key, a computing device derives the first and second portions of the cypher key and plugs the values into the equation.

For example, suppose the key/value in this example to be used (such as to use in decompression or decryption) is 18033988749894848204. In this example, the cypher key is “a” in the formula, and can be “10”, and the mantissas of possible values to test are 19803902718556966005, 44030650891055017975, 18033988749894848204, 66190378969060094174, 20655561573370295189, 80624857586569737297, etc. for “b” in the formula. This results in a hypotenuse value of 2, 3, 4, 5, 6, 7, 8, etc., resulting in a compression ratio of 20:1.

It should be appreciated that the above examples of equations are just some of the mathematical functions that could be used. Other mathematical functions that could be used are those that have increased complexity. In each of these, the computing device that wishes to derive the target sequence will have to derive possible values for the first and second (and additional) portions of the cypher key to find the correct inputs for the function. This provides a deterministic approach to finding the correct keys for the de-transformation (i.e., decryption and/or decompression) of the target sequence of data.

At step 120, the computing device identifies a successful one of the resolved set of possible values. The computing device does this by successfully testing the at least first and second members against a confirmation sequence. In embodiments, the confirmation sequence can be an a priori known portion of the target sequence.

In embodiments of the inventive subject matter, the step of testing the first member against the confirmation sequence comprises calculating a result of applying a second mathematical function to both the first member and a second member of the cypher key, and using the results to test the confirmation sequence. For example, the target sequence could include a separately processable portion that is the confirmation sequence, that can be derived solely with the second mathematical function. In another example, a reference value is stored and the first and second members of the cypher key are applied to the second mathematical function. The output of the function is compared against the stored value and if they match, then the first and second portions of the cypher key are confirmed.

Finding a successful one of the resolved possible values from the set means that none of the other possible values in the set would successfully resolve the target sequence.

In embodiments of the inventive subject matter, the successful one of the resolved set of values comprises a portion of a mantissa of an irrational number. In these embodiments, solving a second portion of the cypher key can result in a starting position within the mantissa.

At step 130, the computing device uses the successful one of the possible values to resolve a target sequence. The target sequence can be considered to be data that has been transformed (e.g., encrypted, compressed, etc.). Resolving a target sequence can include a decompression of a compressed target sequence, a decryption of an encrypted target sequence, etc. At step 140, the successfully resolved target sequence is provided by the computing device to a requesting party.

In embodiments of the inventive subject matter, the target sequence can be an encryption and/or decryption key used to encrypt and decrypt data. Thus, the processes discussed herein are determinative forms of generating the cryptography key.

In these embodiments, resolving the target sequence involves using the successful one of the possible values as a decryption key for the encrypted target sequence. In a variation of these embodiments, the successful one of the possible values corresponds to a key from a shared one-time keypad that is used to decrypt the encrypted target sequence.

In embodiments of the inventive subject matter, the ratio of the length of the cypher key to the length of the successful one of the members is between 0.1 and 0.5, inclusive. In other embodiments of the inventive subject matter, the ratio of the length of the cypher key to the length of the successful one of the members is between 0.1 and 0.3, inclusive. In still other embodiments of the inventive subject matter, the ratio of the length of the cypher key to the length of the successful one of the member is greater than zero and less than 0.2, inclusive.

In embodiments of the inventive subject matter, the computing device uses the successful one of the members to perform decompression functions on a part or all of the target sequence.

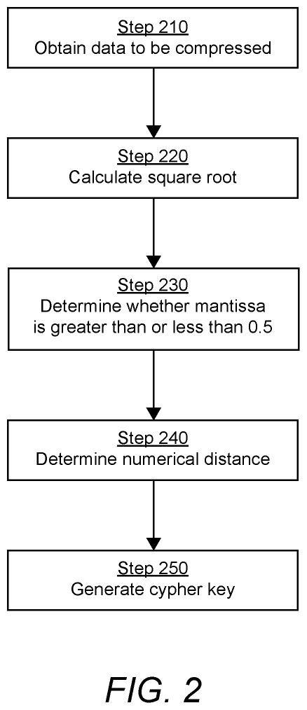

FIG. 2 is a flowchart of an example of a compression process that applies the techniques discussed herein, wherein the first portion of the cypher key is derived and then, for decompression, is used to calculate a distance from a perfect square.

At step 210, a computing device obtains data to be compressed. In order to illustrate the process, this example will use the number “137” as the data to be compressed. It is understood that this is for the purposes of illustration only, and that this process can be applied to significantly larger portions of data. If the data is not numeric at the outset, then the computing device applies a function to convert the data to numeric data.

At step 220, the computing device calculates the square root of the number. In this case, the square root of 137 is calculated to be 11.70469991071963.

At step 230, the computing device determines whether the mantissa of the answer at step 220 is greater than (or equal to) or less than 0.5.

If the mantissa is greater than or equal to 0.5, the computing device is programmed to search for the next perfect square root from the square root value. If the mantissa is less than 0.5, the computing device searches for the previous immediate perfect square root on the number line from the square root value.

In this example, the mantissa of 0.7046991071963 is greater than 0.5, so the computing device searches for the immediate next perfect square from 137. The next perfect square will be the square of the next integer up the number line from 11.7046991071963, which is 12. Thus, the next perfect square is 144.

In other words, at step 230, the computing device will search for the next integer up from the calculated square root value, which is 12, and then square it to obtain the next perfect square of 144.

Had the mantissa in the example above been less than 0.5, the computing device would have searched for the next integer down in the number line (11) and then calculated the square of that number.

At step 240, the computing device determines the numerical distance from the number of the data (137) to the obtained perfect square (144). In this case, the distance is 7 (144 minus 137). Thus, the number 137 is compressed to 7.

At step 250, the computing device stores the compressed data (‘7’) and the number of digits of the original data amount (‘3’). These correspond to the first and section members of the cypher key, and with that the computing device generates the cypher key “73” (the 7 of the data itself and then 3 for the number of digits) to correspond to this compressed data. The computing device can also include an indication of whether the computing device went “up” the number line or “down” the number line from the data to the perfect square number.

Thus, in this example, the compression results in a ⅔ reduction of data usage—a compression ratio of 1:3.

In the processes discussed here, result to be used as a cypher key is a number string. In embodiments of the inventive subject matter, the cypher key can be ultimately created by taking an additional step in processing.

In some embodiments, the cypher key can be created by taking the number string and converting it into an alphanumeric string or an alphabetic string.

In some embodiments, the cypher key can be embedded into a media file such as an image file, video file or audio file. For image files or video files, the computing device can add a watermark or other mark to a certain part of the image or video so that the cypher key is visually depicted. For an audio file (or the audio part of a video file), the cypher key can be incorporated as an audio signal which may or may not be audible to the human ear (but detectable by a computing device via a microphone or other audio sensor).

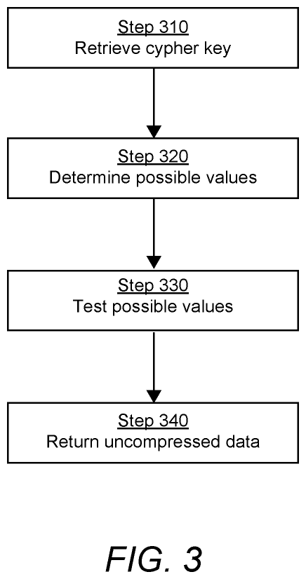

FIG. 3 illustrates a flowchart where the process of uncompressing the data that was compressed in the process of FIG. 2.

At step 310, the computing device retrieves the cypher key 73 that, as discussed above, is made up of the compressed data (‘7’ in this case) and the number of digits of the original data amount (‘3’), in response to a request to decompress the data.

If the cypher key is an alphanumeric or alphabetic string, the computing device reverses the process to first obtain the purely numeric string.

If the cypher key is embedded in a media file such as an image file, a video file or an audio file, the computing device first processes the media file to retrieve the cypher key.

From there, at step 320, the computing device begins to find all of the three-digit numbers that are 7 digits from a perfect square. These can be considered to be the “possible values” of the data. If the direction (up or down) is also stored, the computing device can cut the number of queries in half by only searching in the opposite direction that was searched during the compression (i.e., if the perfect square was found by searching “up”, then the original data value is found by starting at that perfect square and searching “down”).

As the computing device finds the possible values, it tests the possible values at step 330 to determine whether the possible value is correct.

In this example, the process would return, among other values, 121 (a three-digit perfect square of 11) before 144 at step 320 if the process starts at the lowest possible three-digit perfect square, and each one would be tested at step 330. The determination of a correct data value can be performed in one or more of several ways.

In embodiments, the test can include the computing device testing each of the possible values as containing digits that identify a particular file type. For example, certain file types may have certain digits within the data set that are reserved for certain functions or to carry certain data, and those digits will only contain a limited amount of information arranged in specific ways. Thus, any possible values that do not have these digits arranged in a recognized format will be discarded immediately as not being potential matches. An example can including using Apache™ Tika software that a particular set of data is Word file, an Excel file, a binary file, etc.

In other embodiments, the test can include testing a string of digits from the original data (e.g., a “confirmation sequence”) against the possible data values from the possible data set. For example, prior to the compression of FIG. 2, the computing device can record a string of numbers from the original data set, starting at a certain position within the data set, and save this information. Then, at step 330 of FIG. 3., the computing device tests the recorded string of numbers against that same section (i.e., starting at that certain position) for each of the possible values and confirms a possible value to be the correct data value when a match has been found.

When the computing device determines a possible value to be the correct data value, the response with the uncompressed target data (the correct data value) is provided in response to the request at step 340.

In embodiments of the inventive subject matter, the set of possible values to test in the methods discussed above could be over 100 members (100 different sets of possible values). In these embodiments, the computing device can reduce the work required in identifying the correct value by recording a specified digit that the data set ends in. In this way, the computing device can immediately discard or skip over any possible values that do not end in this specified digit. In a variation of these embodiments, the computing device can calculate a digital root for the original data and store that value, such that when testing the possible values for a correct value, the computing device can preferentially test a subset of the possible values that resolve to the correct digital root. Then, the computing device proceeds to test those possible values that resolve to the proper digital root using the methods discussed herein.

In the above discussion, references are made regarding memories and digital logic circuitry. It should be appreciated that the use of such terms is deemed to include servers, services, interfaces, portals, platforms, or other systems formed from computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Also, as used in the description above, and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Still further, all methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context.

What is claimed is:

1. A method of using a cypher key, comprising:
applying a mathematical function to at least a first portion of the cypher key, wherein the function resolves to a set of possible values having at least first and second members;
identifying a successful one of the set of possible values by successively testing at least the first and second members against a confirmation sequence;
using the successful one of the members to resolve a target sequence; and
wherein a length of the cypher key is less than a length of the successful one of the members.

2. The method of claim 1, wherein the step of applying a mathematical function to at least a first portion of the cypher key comprises converting the first portion the cypher key to a numeric key, and applying the mathematical function to the numeric key.

3. The method of claim 1, wherein at least some overlap exists between the confirmation sequence and the target sequence.

4. The method of claim 1, wherein no other members of the set of possible values successfully resolves the target sequence.

5. The method of claim 1, wherein a ratio of the length of the cypher key to the length of the successful one of the members is between 0.1 and 0.5, inclusive.

6. The method of claim 1, wherein a ratio of the length of the cypher key to the length of the successful one of the members is between 0.1 and 0.3, inclusive.

7. The method of claim 1, wherein a ratio of the length of the cypher key to the length of the successful one of the members is greater than zero and less than 0.2, inclusive.

8. The method of claim 1, wherein the first portion of the cypher key comprises an entirely of the cypher key.

9. The method of claim 1, wherein the successful one of the members comprises a portion of a mantissa of an irrational number.

10. The method of claim 9, wherein a second portion of the cypher key comprises resolves to a starting position in the mantissa.

11. The method of claim 1, further comprising using at least part of the successful one of the members to decrypt at least part of the target sequence.

12. The method of claim 11, further comprising using at least part of the successful one of the members as a key pad to decrypt at least part of the target sequence.

13. The method of claim 1, further comprising using the successful one of the members to decompress at least part of the target sequence.

14. The method of claim 1, further comprising using the successful one of the members to losslessly decompress at least a numeric part of the target sequence at a decompression ratio of at least 1:3.

15. The method of claim 1, wherein the step of testing the first member against the confirmation sequence comprises calculating a result of applying a second mathematical function to both the first member and a second portion of the cypher key, and using the result to test the confirmation sequence.

16. The method of claim 1, wherein the first mathematical function comprises using the first portion and a second portion of the cypher key as constants in a polynomial equation.

17. The method of claim 1, wherein the first mathematical function comprises using the first portion and a second portion of the cypher key as constants in calculating a dimension of a geometric figure.

18. The method of claim 1, wherein the first mathematical function comprises using the first portion of the cypher key to calculate a distance from a perfect square.

19. The method of claim 18, wherein a second portion of the cypher key resolves to a number of digits of the successful one of the members.

20. The method of claim 1, wherein the set of possible values comprises at least 100 members other than the first and second members.

21. The method of claim 1, further comprising reducing work in identifying the successful one of the set of possible values by at least preferentially testing a subset of the set of possible values that end in a specified digit.

22. The method of claim 1, further comprising reducing work in identifying the successful one of the set of possible values by at least preferentially testing a subset of the set of possible values that resolve to a specified digital root.

23. The method of claim 1, further comprising identifying the successful one of the members as a function of whether testing the first member of the set against the target sequence identifies the confirmation or target sequence as a known file type.
